(19) United States
(12) Patent Application Publication
(10) Pub. No.: US 2022/0382599 A1
(43) Pub. Date: Dec. 1, 2022

(54) METHOD AND APPARATUS FOR PROCESSING RESOURCE, ELECTRONIC DEVICE AND STORAGE MEDIUM

(71) Applicant: BEIJING DAJIA INTERNET INFORMATION TECHNOLOGY CO., LTD., Beijing (CN)

(72) Inventors: Ye TANG, Beijing (CN); Xiaobo ZHANG, Beijing (CN)

(21) Appl. No.: 17/827,561

(22) Filed: May 27, 2022

(30) Foreign Application Priority Data
May 31, 2021 (CN) 202110601673.2

(51) Int. Cl. G06F 9/50; G06F 21/31

(52) U.S. Cl. CPC G06F 9/5077; G06F 9/5033; G06F 21/31

(57) ABSTRACT

The disclosure relates to processing a multimedia resource, including acquiring resource presentation data determined based on a resource style type of a resource to be processed and account information of a third user account. The resource presentation data includes presentation data of the joint virtual space including the first user account for activating the joint virtual space and the second user account participating in the joint virtual space. Based on anchor information corresponding to the second user account that meets the preset association condition with the third user account from the resource presentation data, the target resource presentation data bound with the joint virtual space is determined.

### CROSS-REFERENCE TO RELATED APPLICATIONS

This application claims priority to Chinese Patent Application No. 202110601673.2, titled METHOD AND APPARATUS FOR PROCESSING RESOURCE, ELECTRONIC DEVICE AND STORAGE MEDIUM, filed May 31, 2021, the entire content of which is incorporated herein by reference.

### TECHNICAL FIELD

The disclosure relates to the field of computer technologies, and in particular, to methods, apparatuses, systems, and non-transitory computer-readable media for processing a multimedia resource.

### BACKGROUND

With the development of multimedia technology, each user can upload multimedia resources to a multimedia platform. The multimedia resources are usually distributed through a content distribution system, so that users can watch or operate the distributed multimedia resource.

In the related art, in distributing multimedia resources, the distribution resources and distribution forms mainly depend on a single dimension, i.e., the resource publisher. Only the resource content closely related to the resource publisher relationship chain is distributed.

### SUMMARY

The disclosure provides methods, apparatuses, and non-transitory computer-readable media for processing a multimedia resource.

According to some arrangements of the disclosure, a method for processing a resource includes:

acquiring resource presentation data determined based on a resource style type of a resource and account information of a third user account, wherein the resource presentation data includes presentation data of joint virtual space, an account of the joint virtual space includes a first user account for activating the joint virtual space and a second user account participating in the joint virtual space, the second user account and the third user account meet a first condition related to association;

determining user information corresponding to the second user account from the resource presentation data; and

determining target resource presentation data of the resource based on the user information corresponding to the second user account, wherein the target resource presentation data is bound with the joint virtual space.

According to some arrangements of the disclosure, a method for processing a resource includes:

acquiring a presentation data acquisition request, wherein the presentation data acquisition request includes a resource style type of a resource and account information of a third user account;

determining resource presentation data based on the resource style type and the account information of the third user account, wherein the resource presentation data includes presentation data of joint virtual space, an account of the joint virtual space includes a first user account for activating the joint virtual space and a second user account participating in the joint virtual space, the second user account and the third user account meet a first condition related to association; and

sending the resource presentation data, wherein the resource presentation data is used to determine user information corresponding to the second user account, the user information corresponding to the second user account is used to determine target resource presentation data of the resource, the target resource presentation data is bound with the joint virtual space.

According to some arrangements of the disclosure, an apparatus for processing a resource includes:

a processor;

a memory for storing instructions executable by the processor,

wherein the processor is configured to:

acquire resource presentation data determined based on a resource style type of a resource and account information of a third user account, wherein the resource presentation data includes presentation data of joint virtual space, an account of the joint virtual space includes a first user account for activating the joint virtual space and a second user account participating in the joint virtual space, the second user account and the third user account meet a first condition related to association;

determine user information corresponding to the second user account from the resource presentation data; and

determine target resource presentation data of the resource based on the user information corresponding to the second user account, wherein the target resource presentation data is bound with the joint virtual space.

According to some arrangements of the disclosure, a computer program product, including a computer program, wherein, when executed by a processor, the computer program implements any method described herein.

It should be noted that the above general description and the following detailed description are merely example and explanatory and should not be construed as limiting of the disclosure.

### BRIEF DESCRIPTION OF THE DRAWINGS

The drawings herein are incorporated into the specification and constitute a part of the specification, show arrangements conforming to the disclosure, and are used to explain the principle of the disclosure together with the specification, and do not constitute an improper limitation of the disclosure.

FIG. 1 is an architectural diagram of a system for applying a method for processing a resource according to an example arrangement.

FIG. 2 is a flow chart of a method for processing a resource according to an example arrangement.

FIG. 3 is a flow chart of determining target resource presentation data according to an example arrangement.

FIG. 4 is a flow chart of a method for processing a resource according to another example arrangement.

FIG. 5 is a flow chart showing steps of determining resource presentation data according to an example arrangement.

FIG. 6 is a sequence diagram of a method for processing a resource according to an example arrangement.

FIG. 7 is a schematic interface diagram of a method for processing a resource in different application scenarios according to an example arrangement.

FIG. 8 is a block diagram of an apparatus for processing a resource according to an example arrangement.

FIG. 9 is a block diagram of an apparatus for processing a resource according to another example arrangement.

FIG. 10 is a block diagram of an electronic device according to an example arrangement.

FIG. 11 is a block diagram of an electronic device according to another example arrangement.

### DETAILED DESCRIPTION

In order to make those skilled in the art better understand the technical solutions of the disclosure, the technical solutions in the arrangements of the disclosure will be clearly and completely described below with reference to the accompanying drawings.

It should be noted that the terms “first”, “second” and the like in the description and claims of the disclosure and the above drawings are used to distinguish similar objects, and are not necessarily used to describe a specific sequence or order. It is to be understood that the data so used are interchangeable under appropriate circumstances, so that the arrangements of the disclosure described herein can be practiced in sequences other than those illustrated or described herein. The implementations described in the illustrative examples below are not intended to represent all implementations consistent with this disclosure. Rather, they are merely examples of apparatus and methods consistent with some aspects of the disclosure as recited in the appended claims.

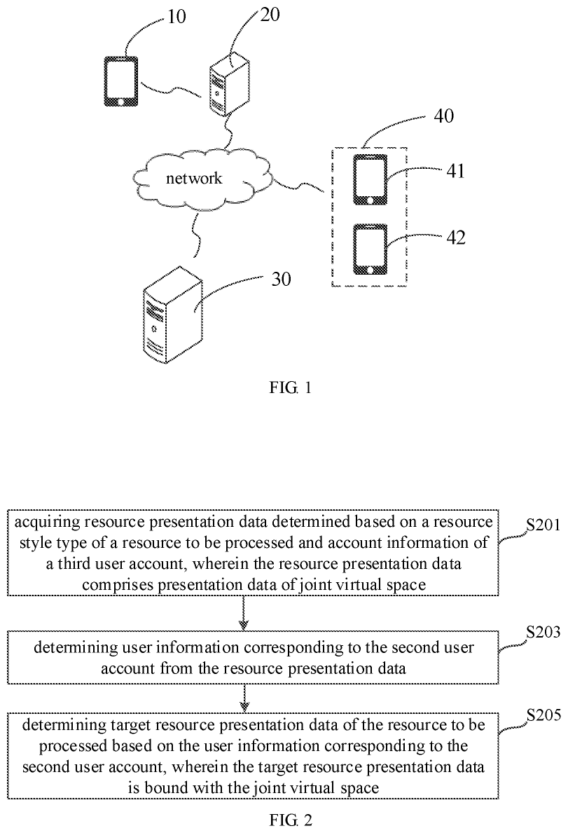

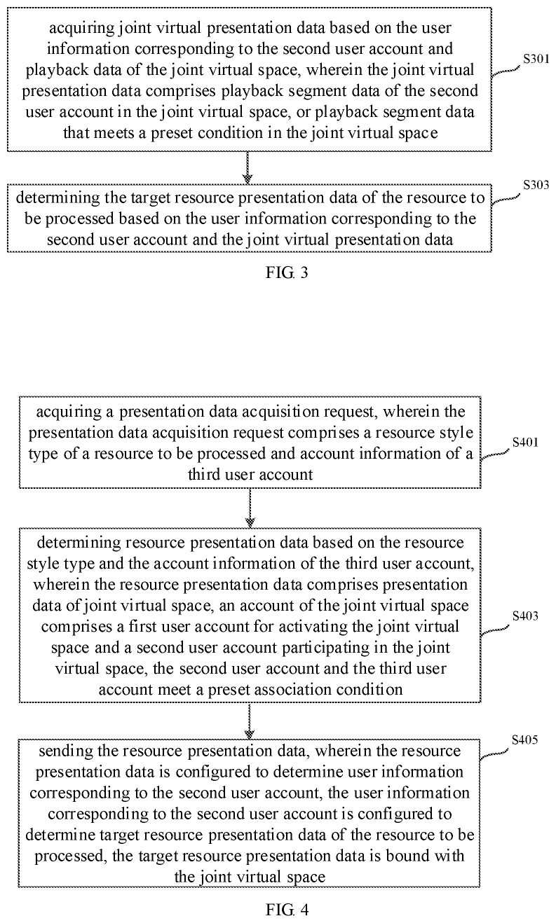

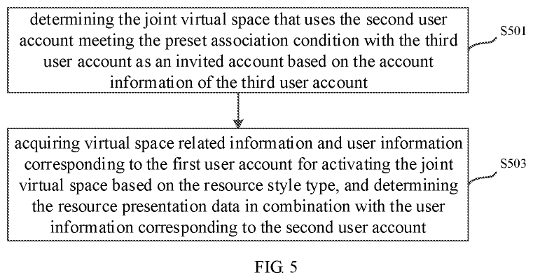

FIG. 1 is an architectural diagram of a system for applying methods for processing a resource according to an example arrangement. Referring to FIG. 1, the architecture diagram may include an audience terminal 10, a resource distribution terminal 20, a server 30, and an anchor terminal 40.

The anchor terminal 40 may include at least a first anchor terminal 41 and a second anchor terminal 42.

The resource distribution terminal 20 may be, but not limited to, an independent server, a server cluster or a distributed system composed of a plurality of physical servers, and may also be one or more of a cloud server that provides basic cloud computing services such as cloud services, cloud databases, cloud computing, cloud functions, cloud storage, network services, cloud communications, intermediate services, domain name services, security services, and big data and artificial intelligence platforms.

The audience terminal 10, the first anchor terminal 41 and the second anchor terminal 42 may include, but not limited to, or one or more of physical devices such as smart phones, tablet computers, laptop computers, desktop computers, smart speakers, smart wearable devices, digital assistants, augmented reality devices, and virtual reality devices, or applications and small programs running in the physical device. The audience terminal 10, the first anchor terminal 41 and the second anchor terminal 42 may correspond to the third user account, the first user account and the second user account in the disclosure, respectively. It should be noted that the number of the audience terminal 10, the first anchor terminal 41 and the second anchor terminal 42 can be modified according to actual needs. In addition, when the first anchor terminal 41 and the second anchor terminal 42 watch the live streaming of other anchors, they can become the audience terminals, and the audience terminal 10 can also become the anchor terminal, which is not limited in arrangements of the disclosure.

The server 30 may provide background services for live streaming data processing for the resource distribution terminal 20, the first anchor terminal 41 and the second anchor terminal 42. For example, the server 30 may be, but not limited to, an independent server, or a server cluster or a distributed system composed of plurality of physical servers, or may also be one or more of a cloud server that provides basic cloud computing services such as cloud services, cloud databases, cloud computing, cloud functions, cloud storage, network services, cloud communications, intermediate services, domain name services, security services, and big data and artificial intelligence platforms. The server 30 and the resource distribution terminal 20, the first anchor terminal 41 and the second anchor terminal 42 may be directly or indirectly connected through wired or wireless communication, which is not limited in arrangements of the disclosure.

The methods for processing a resource provided by arrangements of the disclosure may be executed by an apparatus for processing a resource. The apparatus for processing a resource may be integrated in an electronic device such as a terminal or a server in the form of hardware or software, or may be implemented by the terminal or the server alone, or may be implemented by the terminal and the server cooperatively.

FIG. 2 is a flow chart of a method for processing a resource according to an example arrangement. As shown in FIG. 2, the method for processing the resource can be applied to an electronic device. For example, the electronic device is the resource distribution terminal in FIG. 1. The method includes the following steps.

In S201, resource presentation data determined based on a resource style type of a resource to be processed and account information of a third user account is acquired, wherein the resource presentation data includes presentation data of joint virtual space, an account of the joint virtual space includes a first user account for activating the joint virtual space and a second user account participating in the joint virtual space, the second user account and the third user account meet a first condition related to association.

The resource to be processed may include virtual space resource that needs to be processed. The virtual space is a functional module that exists in a network application to distinguish from the real space. For example, the virtual space can be a live streaming room. The live streaming room is a functional module used to perform live streaming in a network application. The virtual space resource may include live streaming resources. The live streaming resource may be classified into single live streaming and joint live streaming according to the number of anchors. The joint live streaming is joint live streaming between at least two anchors, which can be realized by a live streaming manner such as connecting the microphones or PK battle.

In some arrangements of the disclosure, the resource to be processed may be presented in the form of a resource page in the multimedia platform, and the resource style types of the corresponding resource pages are different in different scenarios or terminals. For example, at least one resource page including but not limited to “Follow”, “Search”, “Same City”, “Featured”, “Plaza”, etc. may exist in the multimedia resource. Users can obtain media resources they are interested in by entering different resource pages. Different resource pages often have different resource style types, such as “Follow” style type, “Search” style type, “Same City” style type, “Featured” style type, “Plaza” style type, and so on. Through different resource style types, resource presentation data with different data structures can be presented in different resource pages.

The third user account may be an account corresponding to a user who needs to watch the virtual space resource, such as an audience account. The account information of the third user account may include at least one of user basic information, user operation data (e.g., follow, search terms), historical preference data, and the like.

In practical applications, the resource style type of the resource to be processed and the account information of the third user account can be obtained first, and then a presentation data acquisition request can be generated. The presentation data acquisition request includes the resource style type and the account information of the third user account. The presentation data acquisition request is used to determine resource presentation data based on the acquired resource style type of the resource to be processed and the account information of the third user account.

In some arrangements of the disclosure, the above-mentioned step of determining resource presentation data may be performed on a server. At this time, determining the resource presentation data based on the acquired resource style type of the resource to be processed and the account information of the third user account may include: the server acquiring the sent presentation data acquisition request, determining the joint virtual space that uses the second user account meeting the first condition with the third user account as an invited account based on the account information of the third user account in the presentation data acquisition request, acquiring live streaming information of the first user account for activating the joint virtual space based on the resource style type, and determining the resource presentation data in combination with the user information corresponding to the second user account.

The resource presentation data includes presentation data of the joint virtual space including the first user account as the joint virtual space start-up account and the second user account. That is, the joint virtual space corresponding to the resource presentation data is dominated by the first user account, and at least includes the joint virtual space in which the second user account participates. Taking the joint virtual space as the joint live streaming space as an example, the first user account can be the first anchor account, the second user account can be the second anchor account, the joint live streaming space is activated or initiated by the first anchor account, and the second anchor account participates in this joint live streaming space as a guest to conduct joint live streaming with the first anchor account.

The second user account and the third user account meet the first condition related to association. The first condition includes the second user account is at least one of a user account followed by the third user account, a user account that belongs to an identical city as a geographic location of the third user account, a user account searched through a terminal corresponding to the third user account, and a user account having a recommended matching degree with the third user account reaching a matching degree threshold. For example, taking the joint virtual space as the joint live streaming space as an example, the second user account can be at least one of the anchor account that the third user account follows and participates in the joint live streaming, the anchor account that belongs to an identical city as a geographic location of the third user account and participates in the joint live streaming, the anchor account obtained by the third user account through the anchor search and participating in the joint live streaming, and the anchor account having a recommended matching degree with the third user account reaching a matching degree threshold and participating in the joint live streaming.

It should be noted that the first user account and the third user account may not meet the above-mentioned first condition. That is, there may be no direct association between the first user account and the third user account or there may be indirect association between the first user account and the third user account.

In some arrangements of the disclosure, the joint virtual space that uses the second user account meeting the first condition with the third user account as an invited account may be determined based on the account information of the third user account. After the joint virtual space is determined, the data structure of the virtual space information to be acquired is then determined according to the resource style type, and virtual space related information and the user information of the first user account for activating the joint virtual space are acquired. Taking the joint virtual space as the joint live streaming space as an example, the user information includes but not limited to at least one of the anchor ID, the anchor nickname, the anchor portrait address and the cover of the live streaming room. The virtual space related information includes but not limited to the live streaming room ID and the basic data of the live streaming room, etc. Next, user information corresponding to the second user account may also be acquired. The user information corresponding to the second user account may include, but not limited to, at least one of the user ID, user portrait, user nickname, and virtual space cover. Taking the joint live streaming space as an example, the user information corresponding to the second user account may include the joint anchor ID, the joint anchor nickname, the joint anchor portrait address, and the cover of the joint anchor live streaming room. Next, the user information corresponding to the second user account may be inserted into the data structure corresponding to the virtual space related information and the user information corresponding to the first user account as a newly added field, to obtain resource presentation data.

In the above arrangement, the resource presentation data can be determined by the server based on the acquired resource style type of the resource to be processed and the account information of the third user account, which can reduce the calculation amount of the resource distribution terminal, improve the resource distribution or presentation efficiency, make the whole process insensitive to users, and improve user experience.

In S203, user information corresponding to the second user account is determined from the resource presentation data.

The user information corresponding to the second user account includes at least one of a user ID, a user portrait, a user nickname, and a virtual space cover. Taking the joint live streaming space as an example, the user information corresponding to the second user account includes at least one of an anchor portrait, a user nickname, and a user space cover.

In some arrangements of the disclosure, said determining the user information corresponding to the second user account from the resource presentation data includes following steps.

Additional field data corresponding to the second user account is parsed out from the resource presentation data.

In some arrangements of the disclosure, under normal circumstances, as for the live streaming room data dominated by the first user account presented by the joint virtual space, i.e., the relevant information of the first user account (such as user portrait, nickname, etc.) usually presented in the resource list page, its corresponding presentation data structure only includes basic fields corresponding to the user information of the first user account. However, the resource presentation data obtained in the disclosure is determined by combining the user information of the first user account and the user information corresponding to the second user account. That is, the resource presentation data includes the basic fields corresponding to the first user account, and also includes the newly added fields corresponding to the second user account. By comparing the difference between the determined resource presentation data and the traditional resource presentation data, the newly added fields corresponding to the second user account can be determined, and the additional field data corresponding to the second user account can be parsed out. The additional field data corresponds to the user information corresponding to the second user account, i.e., including at least one of a user portrait field, a user nickname field, and a virtual space cover field.

The user information corresponding to the second user account is determined based on the additional field data.

In some arrangements of the disclosure, after the additional field data corresponding to the second user account is determined, the user information under the corresponding additional fields can be obtained respectively.

In the above arrangement, additional field data corresponding to the second user account is parsed out from the resource presentation data, and the user information corresponding to the second user account is determined based on the additional field data. In this way, the anchor information corresponding to the second user account can be quickly determined based on the newly added additional fields of the data structure in the resource presentation data, which saves computational time and improves resource processing efficiency.

In S205, target resource presentation data of the resource to be processed is determined based on the user information corresponding to the second user account, wherein the target resource presentation data is bound with the joint virtual space.

In some arrangements of the disclosure, after the user information corresponding to the second user account is determined, the target resource presentation data may be determined according to the user information corresponding to the second user account. The target resource presentation data is used to present on the terminal corresponding to the third user account. Therefore, in the resource page on the terminal corresponding to the third user account, the user information corresponding to the second user account can be presented as the presentation data of the joint virtual space. That is, in the corresponding position of the joint virtual space where the user information of the first user account was originally presented, it is replaced to present the nickname, portrait link, virtual space cover, etc. corresponding to the second user account. In this way, when the audience user corresponding to the third user account browses the joint virtual space, he/she will first see the information corresponding to the second user account that meets the first condition with himself/herself, but not the information corresponding to the first user account that activates the joint virtual space. The target resource presentation data is bound with the joint virtual space, so that the user can directly jump to the corresponding joint virtual space to view more detailed virtual space contents according to the binding relationship between the target resource presentation data and the joint virtual space when it is determined to select the target resource presentation data.

In arrangements of the disclosure, resource presentation data determined based on a resource style type of a resource to be processed and account information of a third user account is acquired, wherein the resource presentation data includes presentation data of joint virtual space, an account of the joint virtual space includes a first user account for activating the joint virtual space and a second user account participating in the joint virtual space, the second user account and the third user account meet a first condition; target resource presentation data bound with the joint virtual space is determined based on user information corresponding to the second user account determined from the resource presentation data. In this way, when the joint virtual space is distributed, the target resource presentation data with the second user account that meets the first condition with the target audience account as the main body is distributed, and the virtual space data with the first user account for activating the joint virtual space that is irrelevant with the third user account as the main body is avoided from distributing, which not only increases the exposure rate of the joint virtual space, but also improves the user's click rate on the exposed joint virtual space, and at the same time enriches the content and form of resource distribution, which is conducive to improving the user viscosity of the multimedia platform.

In some arrangements of the disclosure, before determining the target resource presentation data of the resource to be processed based on the user information corresponding to the second user account, the method further includes:

S301, acquiring joint virtual presentation data based on the user information corresponding to the second user account and playback data of the joint virtual space, wherein the joint virtual presentation data includes playback segment data of the second user account in the joint virtual space, or playback segment data that meets a second condition in the joint virtual space.

In some arrangements of the disclosure, the playback segment data of the second user account in the joint virtual space may be determined according to the user information corresponding to the second user account and the playback data of the joint virtual space, and the playback segment data corresponding to the second user account is used as joint virtual presentation data.

It should be noted that, in a scenario where the third user account has a strong demand for the second user account, that is, a scenario where the third user account and the second user account have a strong relationship, the playback segment data corresponding to the second user account may be used as the joint virtual presentation data. For example, in a “follow” scenario, the second user account is a follower of the third user account, and there is a strong correlation between them two. For another example, in a “search” scenario, the second user account is the search object of the third user account, and there is a strong correlation between them two. In these two scenarios, the playback segment data corresponding to the second user account may be used as the joint virtual presentation data first.

In some arrangements of the disclosure, when it is determined that the playback segment data corresponding to the second user account is an invalid playback content, the playback segment data that meets the second condition in the joint virtual space may be acquired according to the live streaming data of the joint virtual space, and the acquired playback segment data is used as the joint live streaming presentation data. The invalid playback content refers to whether the second user account in the joint virtual space performs valid content output. In some arrangements of the disclosure, for example, an audio recognition module or a gesture recognition module may be used to detect whether the user corresponding to the second user account in the joint virtual space performs content output such as speaking, singing, dancing, etc. The playback segment data that meets the second condition refers to the playback segment data whose playback content quality meets the preset quality requirement, such as highlight data and the like.

In the scenario where the third user account does not have a strong demand for the second user account, that is, in the scenario where there is a weak relationship between the third user account and the second user account, the playback segment data that meets the second condition in the joint virtual space can be obtained directly according to the playback data of the joint virtual space, and the acquired playback segment data can be used as the joint virtual presentation data, without acquiring the playback segment data of the second user account in the joint virtual space in advance. For example, in the recommendation scenarios such as “same city” scenario, “featured” scenario or “plaza” scenario, there is a weak relationship between the third user account and the second user account. In these scenarios, the playback segment data that meets the second condition in the joint virtual space can be directly used as joint virtual presentation data.

Correspondingly, said determining the target resource presentation data of the resource to be processed based on the user information corresponding to the second user account includes:

S303, determining the target resource presentation data of the resource to be processed based on the user information corresponding to the second user account and the joint virtual presentation data.

In some arrangements of the disclosure, after acquiring the user information corresponding to the second user account and the joint virtual presentation data, they may be used as the target resource presentation data of the resource to be processed, so as to be presented in the resource page. In some arrangements of the disclosure, the target resource presentation data can be presented in the resource page in the form of a card. The user information corresponding to the second user account is presented in the corresponding position of the card according to the resource style type. Specifically, at least one of the user portrait, user nickname, and virtual space cover corresponding to the second user account is presented in the corresponding position in the card. When the user corresponding to the third user account browses to the card corresponding to the joint virtual space, what he sees first is the statically presented user information corresponding to the second user account. Next, when the user corresponding to the third user account slides to the card corresponding to the joint virtual space, the joint virtual presentation data can be dynamically presented in the card.

In the above-mentioned arrangement, based on the user information corresponding to the second user account and the playback data of the joint virtual space, combined with the strong or weak relationship between the second user account and the third user account, customized joint virtual presentation data is determined for different types of audiences, to distribute more attractive contents for different types of audiences, so as to improve the exposure rate and click rate of the distributed or presented content. As for multi-person joint virtual space, it can increase the probability that users corresponding to the joint virtual space (such as joint anchors) will be followed, thus increasing user viscosity.

In some arrangements of the disclosure, the method further includes following steps.

The target resource presentation data is sent to the third user account, such that a terminal where the third user account is located presents the target resource presentation data.

In some arrangements of the disclosure, after acquiring the target resource presentation data, the resource distribution terminal may send the target resource presentation data to the third user account, so that the terminal where the third user account is located presents the target resource presentation data.

It should be noted that, the above-mentioned resource processing method can also be applied to the audience terminal in the above-mentioned schematic diagram of the implementation environment. At this time, after determining the target resource presentation data of the resource to be processed based on the user information corresponding to the second user account, the method may further include:

presenting the target resource presentation data.

In some arrangements of the disclosure, after acquiring the target resource presentation data, the audience terminal may present the target resource presentation data in the resource page. Afterwards, the audience terminal may jump to the page corresponding to the joint virtual space bound with the target resource presentation data in response to the selection operation of the target resource presentation data by the third user account, and view the virtual space content by entering the joint virtual space.

In this way, when the joint virtual space is presented, the target resource presentation data with the second user account that meets the first condition with the target audience account as the main body is presented, and the virtual space data with the first user account for activating the joint virtual space that is irrelevant with the third user account as the main body is avoided from presenting, which not only increases the exposure rate of the joint virtual space, but also improves the user's click rate on the exposed joint virtual space, and at the same time enriches the content and form of resource distribution, which is conducive to improving the user viscosity of the multimedia platform.

FIG. 4 is a flow chart of a method for processing a resource according to another example arrangement. As shown in FIG. 4, the method for processing the resource can be applied to an electronic device. For example, the electronic device is the server in the above schematic diagram of the implementation environment for illustration. The method includes the following steps:

S401, acquiring a presentation data acquisition request, wherein the presentation data acquisition request includes a resource style type of a resource to be processed and account information of a third user account;

S403, determining resource presentation data based on the resource style type and the account information of the third user account, wherein the resource presentation data includes presentation data of joint virtual space, an account of the joint virtual space includes a first user account for activating the joint virtual space and a second user account participating in the joint virtual space, the second user account and the third user account meet a first condition related to association; and

S405, sending the resource presentation data, wherein the resource presentation data is configured to determine user information corresponding to the second user account, the user information corresponding to the second user account is configured to determine target resource presentation data of the resource to be processed, the target resource presentation data is bound with the joint virtual space.

The specific content and beneficial effects of the foregoing arrangements may refer to the foregoing arrangements, which will not be repeated here.

In some arrangements of the disclosure, said determining the resource presentation data based on the resource style type and the account information of the third user account includes:

S501, determining the joint virtual space that uses the second user account meeting the first condition with the third user account as an invited account based on the account information of the third user account;

S503, acquiring virtual space related information and user information of the first user account for activating the joint virtual space based on the resource style type, and determining the resource presentation data in combination with the user information corresponding to the second user account.

In some arrangements of the disclosure, the server may determine the joint virtual space that uses the second user account meeting the first condition with the third user account as an invited account based on the account information of the third user account. After the joint virtual space is determined, the data structure of the user information to be acquired is then determined according to the resource style type, and virtual space related information and the user information of the first user account for activating the joint virtual space are acquired. Taking the joint virtual space as the joint live streaming space as an example, the user information includes but not limited to at least one of the anchor ID, the anchor nickname, the anchor portrait address and the cover of the live streaming room. The virtual space related information includes but not limited to at least one of the live streaming room ID and the basic data of the live streaming room, etc. The server may also acquire user information corresponding to the second user account. The user information corresponding to the second user account may include, but not limited to, at least one of the user ID, user portrait, user nickname, and virtual space cover. Next, the server may insert the user information corresponding to the second user account into the data structure corresponding to the virtual space related information and the user information corresponding to the first user account as a newly added field, to obtain resource presentation data.

In the above arrangement, the server inserts the user information corresponding to the second user account into the data structure corresponding to the user information corresponding to the first user account as a newly added field, to obtain resource presentation data. In this way, the user information corresponding to the second user account is merged by inserting fields, without changing the basic data structure of the traditional resource presentation data, avoiding the logical problem caused by directly replacing the user information of the first user account, effectively reducing the workload of resource data processing and improving the efficiency of resource data processing.

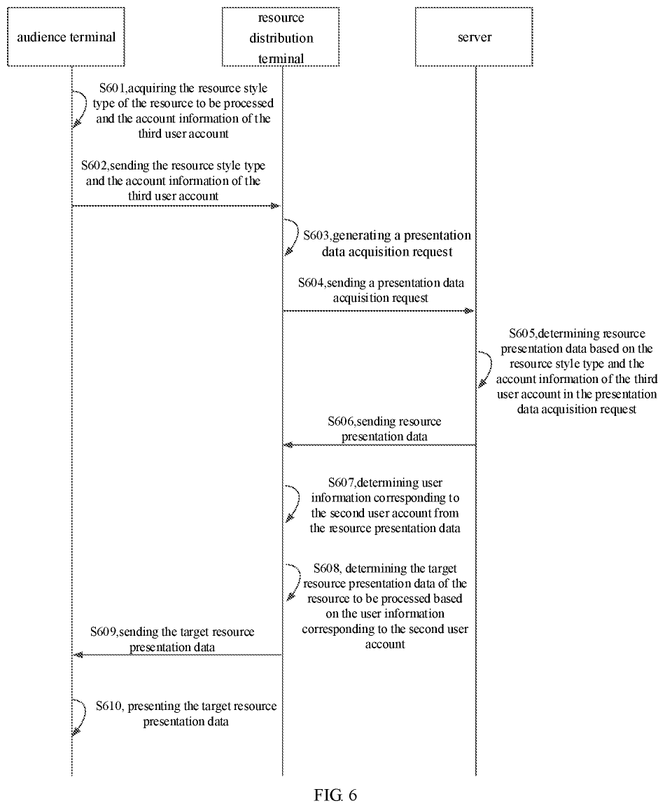

FIG. 6 is a sequence diagram of a method for processing a resource according to an example arrangement. As shown in FIG. 6, the method for processing the resource can be applied to an electronic device, and for example, the electronic device is the above-mentioned schematic diagram of the implementation environment for illustration. The method includes the following steps.

In S601, the audience terminal acquires the resource style type of the resource to be processed and the account information of the third user account.

In S602, the audience terminal uploads the resource style type and the account information of the third user account to the content distribution terminal.

In S603, the content distribution terminal generates a presentation data acquisition request, where the presentation data acquisition request includes the resource style type and account information of the third user account.

In S604, the content distribution terminal sends a presentation data acquisition request to the server.

In S605, the server determines resource presentation data based on the resource style type and the account information of the third user account in the presentation data acquisition request.

The resource presentation data includes presentation data of joint virtual space, an account of the joint virtual space includes a first user account for activating the joint virtual space and a second user account participating in the joint virtual space, the second user account and the third user account meet a first condition related to association.

In S606, the server sends resource presentation data to the content distribution terminal.

In S607, the content distribution terminal determines user information corresponding to the second user account from the resource presentation data.

In S608, the content distribution terminal determines the target resource presentation data of the resource to be processed based on the user information corresponding to the second user account.

The target resource presentation data is bound with the joint virtual space.

In S609, the content distribution terminal sends the target resource presentation data to the audience terminal.

In S610, the audience terminal presents the target resource presentation data.

For the specific content and beneficial effects of the foregoing arrangements, reference may be made to the foregoing arrangements, which will not be repeated here.

In the following, a method for processing the resource involved in the disclosure will be described in combination with specific application scenarios, where, for example, the joint virtual space is the joint live streaming room, anchor A is the first user account, anchor B is the second user account, anchor A invites anchor B to initiate the joint anchor, anchor A is associated with the live streaming room, and the anchor B is the joint anchor in the live streaming room.

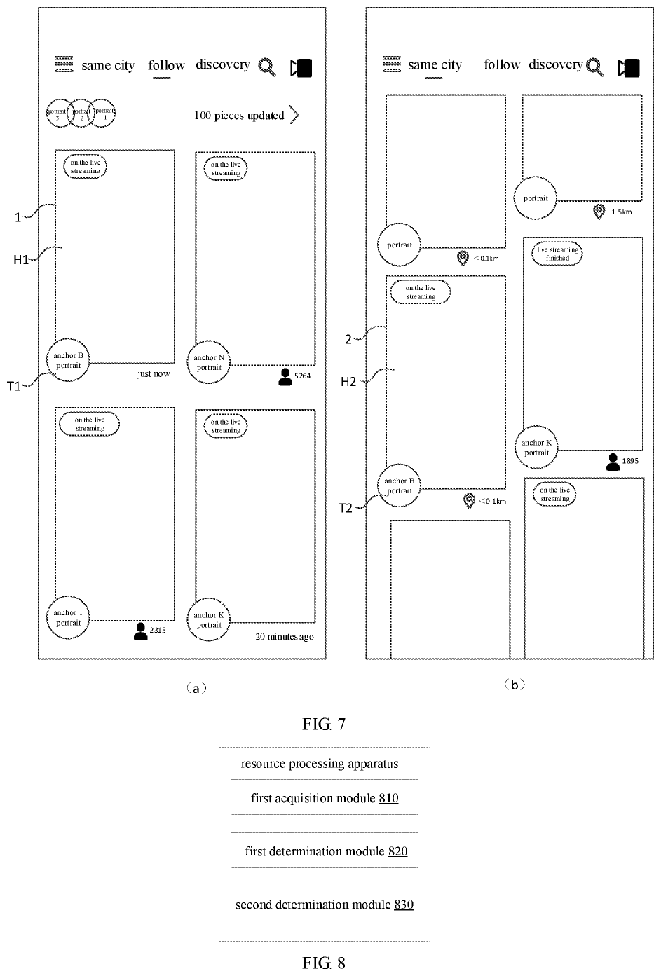

In the “follow” scenario, audience A is a fan of anchor B, and audience A enters the follow page in the multimedia platform, and can transmit the current follow page style type to the resource distribution terminal (such as the distribution management system). The resource distribution terminal requests the server for follow presentation data. The server returns the anchor information of the live streaming room with anchor A as the anchor and inserting joint anchor B as the resource presentation data. The resource distribution terminal determines the anchor information corresponding to anchor B according to the difference between the inserted newly added fields and the traditional distribution data structure, in order to present the target resource presentation data such as the anchor portrait and live streaming cover with anchor B as the main body on the audience A terminal. As shown in (a) in FIG. 7, in the follow resource page, card 1 is the joint live streaming launched by anchor A. The portrait area T1 in card 1 displays the portrait of joint anchor B. The card content area H1 statically displays the live streaming cover of joint anchor B, that is, the target resource presentation data with anchor B as the theme is displayed on card 1. Next, the resource distribution terminal may request the live streaming segment data with the anchor B as the main body from the server. After the request is completed, audience A will see the live streaming segment data with anchor B as the main body at the corresponding position in the follow list page. For example, the live streaming segment data with anchor B as the main body is dynamically displayed in the H1 area of card 1. After clicking to enter the card 1, it is the joint virtual space of anchor A and anchor B. When the corresponding anchor B does not output effective joint live streaming contents, the highlights of the current joint live streaming may be requested to obtain. After the request is completed, audience A can see the highlight data of the current joint live streaming at the corresponding anchor location in the resource page, for example, highlight data in the current joint live streaming in the H1 area in card 1. After clicking to enter, it is the joint virtual space of anchor A and anchor B.

In the “search” scenario, when audience B searches for anchor B through search, the current search style type and search keywords are sent to the resource distribution terminal (such as the distribution management system). The resource distribution terminal requests the server for search presentation data. The server returns the anchor information of the live streaming room with anchor A as the anchor and inserting joint anchor B as the resource presentation data. The resource distribution terminal determines the anchor information corresponding to anchor B according to the difference between the inserted newly added fields and the traditional distribution data structure, so as to present the target resource presentation data such as the live streaming cover and the anchor portrait with anchor B as the main body on the audience B terminal. When the resource distribution terminal returns the search presentation data, a series of fuzzy search results will be presented. When audience B slides to anchor B, the resource distribution terminal will request the server for the live streaming segment data with the anchor B as the main body. After the request is completed, audience B will see the live streaming segment data with anchor B as the main body at the corresponding position on the list page. After clicking to enter, it will be the joint virtual space of anchor A and anchor B. When the corresponding anchor B does not output effective joint live streaming contents, the highlights of the current joint live streaming may be requested to obtain. After the request is completed, audience A can see the highlights of the current joint live streaming at the corresponding anchor location in the list page. After clicking to enter, it is the joint virtual space of anchor A and anchor B.

In the “same city” scenario, when audience C is in the same-city list, the resource distribution terminal (such as the distribution management system) will carry the current user's geographic location information and the same-city style type, and request the same-city list data from the server. According to the geographic location information, the server returns the anchor information of the live streaming room with anchor A as the anchor and inserting the anchor information with the same city as audience C as the resource presentation data. The resource distribution terminal determines the anchor information corresponding to anchor B according to the difference between the inserted newly added fields and the traditional distribution data structure, so as to present the target resource presentation data such as the live streaming cover and the anchor portrait with anchor B as the main body on the audience B terminal. As shown in (b) of FIG. 7, in the follow resource page, card 1 is the joint live streaming launched by anchor A. The portrait area T2 in card 2 displays the portrait of joint anchor B. The card content area H2 statically displays the live streaming cover of joint anchor B. That is, the target resource presentation data with anchor B as the theme is displayed on card 2. Next, the highlights of the joint live streaming may be directly requested, and then presented to the audience C after the request is completed. For example, highlight data in the current joint live streaming is dynamically displayed in the H2 area in card 2.

In a mixed recommendation scenario such as “Featured”, “Plaza”, when audience D is in a mixed list such as “Featured”, “Plaza”, the resource distribution terminal (such as the distribution management system) will carry the current audience ID and recommendation style type, and request recommendation list data from the server. According to the user preferences of audience D, the data model of historical preferences and other information, the server will match the information and content of the corresponding anchors in the joint live streaming, calculate the matching degree of all the anchors in the joint virtual space, and determine the anchor B with the highest matching degree. Next, take the anchor data of the live streaming room with anchor A as the anchor and inserting the anchor data of anchor B with the highest matching degree as the resource presentation data. The resource distribution terminal determines the anchor information corresponding to anchor B according to the difference between the inserted newly added fields and the traditional distribution data structure, so as to present the target resource presentation data such as the live streaming cover and the anchor portrait with anchor B as the main body on the audience B terminal, and directly request the highlights of the joint live streaming, and present it to the audience D after the request is completed.

FIG. 8 is a block diagram of an apparatus for processing a resource according to an example arrangement. Referring to FIG. 8, the apparatus includes:

a first acquisition module 810, configured to acquire resource presentation data determined based on a resource style type of a resource to be processed and account information of a third user account, wherein the resource presentation data includes presentation data of joint virtual space, an account of the joint virtual space includes a first user account for activating the joint virtual space and a second user account participating in the joint virtual space, the second user account and the third user account meet a first condition related to association;

a first determination module 820, configured to determine user information corresponding to the second user account from the resource presentation data; and

a second determination module 830, configured to determine target resource presentation data of the resource to be processed based on the user information corresponding to the second user account, wherein the target resource presentation data is bound with the joint virtual space.

In some arrangements of the disclosure, the apparatus further includes:

a second acquisition module, configured to acquire joint virtual presentation data based on the user information corresponding to the second user account and playback data of the joint virtual space, wherein the joint virtual presentation data includes playback segment data of the second user account in the joint virtual space, or playback segment data that meets a second condition in the joint virtual space;

the second determination module includes:

a determination sub-module, configured to determine the target resource presentation data of the resource to be processed based on the user information corresponding to the second user account and the joint virtual presentation data.

In some arrangements of the disclosure, the apparatus further includes:

a third acquisition module, configured to acquire the resource style type of the resource to be processed and the account information of the third user account;

a request generation module, configured to generate a presentation data acquisition request, wherein the presentation data acquisition request includes the resource style type and the account information of the third user account, the presentation data acquisition request is configured to determine the joint virtual space that uses the second user account meeting the first condition with the third user account as an invited account based on the account information of the third user account, acquire virtual space related information and user information of the first user account for activating the joint virtual space based on the resource style type, and determine the resource presentation data in combination with the user information corresponding to the second user account.

In some arrangements of the disclosure, the first determination module includes:

a parsing sub-module, configured to parse additional field data corresponding to the second user account from the resource presentation data;

a determination sub-module, configured to determine the user information corresponding to the second user account based on the additional field data.

In some arrangements of the disclosure, the user information corresponding to the second user account includes at least one of a user ID, a user portrait, a user nickname, and a virtual space cover;

the first condition includes the second user account is at least one of a user account followed by the third user account, a user account that belongs to an identical city as a geographic location of the third user account, a user account searched through a terminal corresponding to the third user account, and a user account having a recommended matching degree with the third user account reaching a matching degree threshold.

In some arrangements of the disclosure, the apparatus further includes:

a data sending module, configured to send the target resource presentation data to the third user account, such that a terminal where the third user account is located presents the target resource presentation data; or,

a presentation module, configured to present the target resource presentation data.

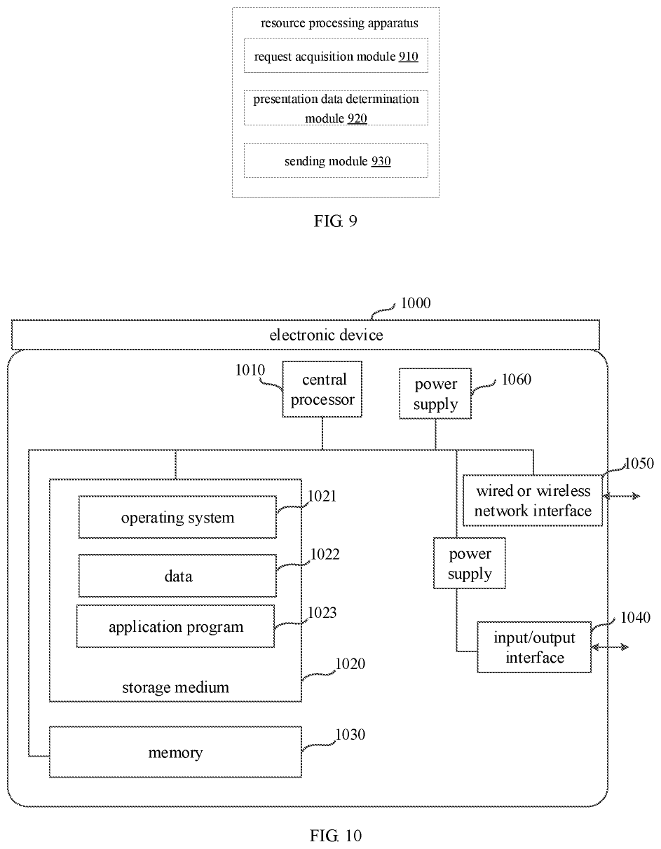

FIG. 9 is a block diagram of an apparatus for processing a resource according to another example arrangement. Referring to FIG. 9, the apparatus includes:

a request acquisition module 910, configured to acquire a presentation data acquisition request, wherein the presentation data acquisition request includes a resource style type of a resource to be processed and account information of a third user account;

a presentation data determination module 920, configured to determine resource presentation data based on the resource style type and the account information of the third user account, wherein the resource presentation data includes presentation data of joint virtual space, an account of the joint virtual space includes a first user account for activating the joint virtual space and a second user account participating in the joint virtual space, the second user account and the third user account meet a first condition; and

a sending module 930, configured to send the resource presentation data, wherein the resource presentation data is configured to determine user information corresponding to the second user account, the user information corresponding to the second user account is configured to determine target resource presentation data of the resource to be processed, the target resource presentation data is bound with the joint virtual space.

In some arrangements of the disclosure, the presentation data determination module includes:

a first determination sub-module, configured to determine the joint virtual space that uses the second user account meeting the first condition with the third user account as an invited account based on the account information of the third user account;

a second determination sub-module, configured to acquire virtual space related information and user information corresponding to the first user account for activating the joint virtual space based on the resource style type, and determine the resource presentation data in combination with the user information corresponding to the second user account.

Regarding the apparatus in the above-mentioned arrangement, the specific manner in which each module performs operations has been described in detail in the arrangement of the method, and will not be described in detail here.

The technical solutions provided by the arrangements of the disclosure bring at least the following beneficial effects.

In arrangements of the disclosure, resource presentation data determined based on a resource style type of a resource to be processed and account information of a third user account is acquired, wherein the resource presentation data includes presentation data of joint virtual space, an account of the joint virtual space includes a first user account for activating the joint virtual space and a second user account participating in the joint virtual space, the second user account and the third user account meet a first condition related to association; target resource presentation data bound with the joint virtual space is determined based on user information corresponding to the second user account determined from the resource presentation data. In this way, when the joint virtual space is distributed, the target resource presentation data with the second user account that meets the first condition with the target audience account as the main body is distributed, and the virtual space data with the first user account for activating the joint virtual space that is irrelevant with the third user account as the main body is avoided from distributing, which not only increases the exposure rate of the joint virtual space, but also improves the user's click rate on the exposed joint virtual space, and at the same time enriches the content and form of resource distribution, which is conducive to improving the user viscosity of the multimedia platform.

FIG. 10 is a block diagram of an electronic device according to an example arrangement. Referring to FIG. 10, the electronic device includes: a processor; a memory for storing instructions executable by the processor, wherein, the processor is configured to execute the instructions stored on the memory to implement steps of any one of the methods for processing a resource described above.

The electronic device may be a terminal, a server or a similar computing device. Taking the electronic device as a server as an example, FIG. 10 is a block diagram of an electronic device for resource processing according to an example arrangement. The electronic device 1000 may have relatively large differences due to different configurations or performances, which may include one or more Central Processing Units (CPU) 1010 (the processor 1010 may include, but not limited to, processing devices such as a microprocessor MCU or a programmable logic device FPGA, etc.), a memory 1030 for storing data, one or more storage media 1020 (e.g., one or more mass storage devices) for storing application programs 1023 or data 1022. The memory 1030 and the storage medium 1020 may be short-term storage or persistent storage. The program stored in the storage medium 1020 may include one or more modules, and each module may include a series of instruction operates on the electronic device. Furthermore, the central processing unit 1010 may be configured to communicate with the storage medium 1020, to execute a series of instruction operations in the storage medium 1020 on the electronic device 1000.

The electronic device 1000 may also include one or more power supplies 1060, one or more wired or wireless network interfaces 1050, one or more input/output interfaces 1040, and/or, one or more operating systems 1021, such as Windows Server, Mac OS X, Unix, Linux, FreeBSD, etc.

The input/output interface 1040 may be used to receive or send data via a network. The specific example of the above-mentioned network may include a wireless network provided by the communication provider of the electronic device 1000. In one example, the input/output interface 1040 includes a Network Interface Controller (NIC), which can be connected to other network devices through the base station, so as to communicate with the Internet. In an example arrangement, the input/output interface 1040 may be a Radio Frequency (RF) module, which is used to communicate with the Internet in a wireless manner.

Those skilled in the art can understand that the structure shown in FIG. 10 is only a schematic diagram, which does not limit the structure of the above electronic device. For example, the electronic device 1000 may also include more or fewer components than those shown in FIG. 10, or have a different configuration from that shown in FIG. 10.

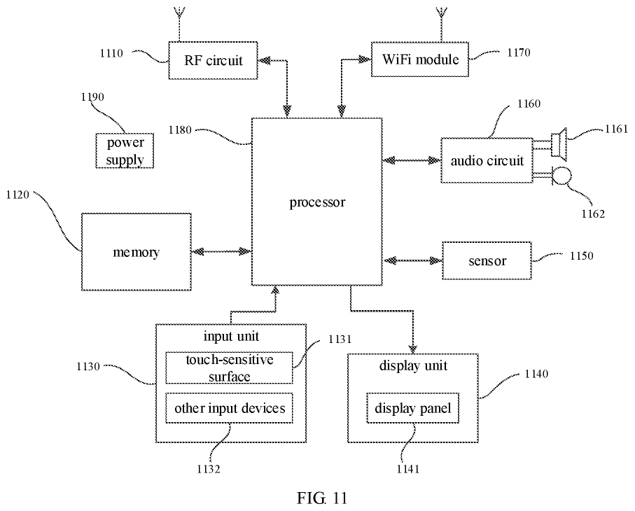

FIG. 11 is a block diagram of an electronic device according to another example arrangement. Referring to FIG. 11, the electronic device includes: a processor; a memory for storing instructions executable by the processor, wherein, the processor is configured to execute the instructions stored on the memory to implement steps of any one of the methods for processing a resource described above.

The electronic device may be a terminal, a server, or a similar computing device. Taking the electronic device as a terminal as an example, FIG. 11 is a block diagram of another electronic device for resource processing according to an example arrangement.

Specifically, the terminal may include an RF (Radio Frequency) circuit 1110, a memory 1120 including one or more computer-readable storage media, an input unit 1130, a display unit 1140, a sensor 1150, an audio circuit 1160, a WiFi (wireless fidelity) module 1170, a processor 1180 including one or more processing cores, a power supply 1190 and other components. Those skilled in the art can understand that the terminal structure shown in FIG. 11 does not constitute a limitation on the terminal, and may include more or less components than those shown in the figure, or combine some components, or arrange different components.

The RF circuit 1110 can be used for receiving and sending signals during the process of sending and receiving information or talking. In particular, after receiving the downlink information of the base station, it is processed by one or more processors 1180. In addition, the data related to the uplink is sent to the base station. Typically, the RF circuit 1110 includes, but not limited to, an antenna, at least one amplifier, a tuner, one or more oscillators, a Subscriber Identity Module (SIM) card, a transceiver, a coupler, an LNA (Low Noise Amplifier), a duplexer, etc. In addition, the RF circuit 1110 can also communicate with the network and other terminals through wireless communication. The wireless communication can use any communication standard or protocol, including but not limited to GSM (Global System of Mobile communication), GPRS (General Packet Radio Service), CDMA (Code Division Multiple Access), WCDMA (Wideband Code Division Multiple Access), LTE (Long Term Evolution), E-mail, SMS (Short Messaging Service) and so on.

The memory 1120 may be used to store software programs and modules. The processor 1180 executes various functional applications and data processing by running the software programs and modules stored in the memory 1120. The memory 1120 may mainly include a storage program area and a storage data area. The storage program area may store an operating system, application programs required for functions, etc. The storage data area may store data created according to the use of the terminal, and the like. Additionally, the memory 1120 may include high-speed random access memory, and may also include non-volatile memory, such as at least one magnetic disk storage device, flash memory device, or other volatile solid state storage device. Accordingly, the memory 1120 may also include a memory controller to provide access to the memory 1120 by the processor 1180 and the input unit 1130.

The input unit 1130 may be used to receive input numerical or character information, and generate keyboard, mouse, joystick, optical or trackball signal input related to user settings and function control. Specifically, the input unit 1130 may include a touch-sensitive surface 1131 as well as other input devices 1132. The touch-sensitive surface 1131, also known as a touch display or touchpad, can collect user touch operations on or near it (such as operation on near the touch-sensitive surface 1131 by a user using a finger, stylus, or any suitable object or accessory), and drive the corresponding connection device according to the preset program. In some arrangements of the disclosure, the touch-sensitive surface 1131 may include two parts, i.e., a touch detection device and a touch controller. The touch detection device detects touch orientation of the user, detects the signal brought by the touch operation, and transmits the signal to the touch controller. The touch controller receives the touch information from the touch detection device, converts it into contact coordinates, and then sends it to the processor 1180, and can receive the commands sent by the processor 1180 and execute them. In addition, the touch-sensitive surface 1131 may be implemented using resistive, capacitive, infrared, and surface acoustic wave types or the like. In addition to the touch-sensitive surface 1131, the input unit 1130 may also include other input devices 1132. Specifically, other input devices 1132 may include, but not limited to, one or more of physical keyboards, function keys (such as volume control keys, switch keys, etc.), trackballs, mouse, joysticks, and the like.

The display unit 1140 may be used to display information input by the user or information provided to the user and various graphical user interfaces of the terminal. The graphical user interface may be composed of graphics, texts, icons, videos and any combination thereof. The display unit 1140 may include a display panel 1141. In some arrangements of the disclosure, the display panel 1141 may be configured in the form of an LCD (Liquid Crystal Display), an OLED (Organic Light-Emitting Diode) and the like. Further, the touch-sensitive surface 1131 may cover the display panel 1141. When the touch-sensitive surface 1131 detects a touch operation on or near it, it is transmitted to the processor 1180 to determine the type of the touch event. Then the processor 1180 provides corresponding visual output on the display panel 1141 according to the type of the touch event. The touch-sensitive surface 1131 and the display panel 1141 can be two independent components to realize the input and input functions. However, in some arrangements, the touch-sensitive surface 1131 and the display panel 1141 can also be integrated to realize the input and output functions.

The terminal may also include at least one sensor 1150, such as a light sensor, a motion sensor, and other sensors. Specifically, the light sensor may include an ambient light sensor and a proximity sensor. The ambient light sensor may adjust the brightness of the display panel 1141 according to the brightness of the ambient light. The proximity sensor may close the display panel 1141 and/or backlight when the terminal is moved to the ear. As a kind of motion sensor, the gravitational acceleration sensor can detect the magnitude of acceleration in all directions (usually three axes), and can detect the magnitude and direction of gravity when it is stationary, and can be used for applications that identify the terminal posture (such as horizontal and vertical screen switching, related games, magnetometer attitude calibration), vibration recognition related functions (such as pedometer, tapping), etc.; as for other sensors such as gyroscope, barometer, hygrometer, thermometer, infrared sensor and other sensors that can be configured by the terminal, it will not be repeated herein.

The audio circuit 1160, the speaker 1161 and the microphone 1162 can provide an audio interface between the user and the terminal. The audio circuit 1160 can convert the received audio data into an electrical signal, and transmit it to the speaker 1161, and the speaker 1161 converts it into a sound signal for output. On the other hand, the microphone 1162 converts the collected sound signal into an electrical signal. The audio circuit 1160 receives and then converts it into audio data, and then the audio data is output to the processor 1180 for processing, and then sent to, for example, another terminal through the RF circuit 1110, or the audio data is output to the memory 1120 for further processing. The audio circuit 1160 may also include an earplug jack, to provide communication of peripheral headphones with the terminal.

WiFi is a short-distance wireless transmission technology, and the terminal can help users to send and receive emails, browse web pages, access streaming media, etc. through the WiFi module 1170, which provides users with wireless broadband Internet access. Although FIG. 11 shows the WiFi module 1170, it can be understood that it does not belong to the necessary component of the terminal, and can be completely omitted as required without changing the scope of the essence of the disclosure.

The processor 1180 is the control center of the terminal, it uses various interfaces and lines to connect various parts of the entire terminal, runs or executes the software programs and/or modules stored in the memory 1120, and calls the data stored in the memory 1120, performs various functions of the terminal and processes data, so as to monitor the terminal as a whole. In some arrangements of the disclosure, the processor 1180 may include one or more processing cores. Preferably, the processor 1180 may integrate an application processor and a modem processor. The application processor mainly processes the operating system, user interface, and application programs, etc. The modem processor mainly deals with wireless communication. It can be understood that, the above-mentioned modulation and demodulation processor may not be integrated into the processor 1180.

The terminal also includes a power supply 1190 (such as a battery) that supplies power to various components. Preferably, the power supply can be logically connected to the processor 1180 through a power management system, so as to manage charging, discharging, and power consumption management functions through the power management system. The power supply 1190 may also include one or more DC or AC power sources, recharging systems, power failure detection circuits, power converters or inverters, power status indicators, and any other components.

Although not shown, the terminal may also include a camera, a Bluetooth module, and the like, which will not be repeated here. Specifically, in this arrangement, the terminal further includes a memory, and one or more programs. The one or more programs are stored in the memory and configured to be executed by one or more processors. The above one or more programs include instructions for executing the method for processing the resource provided by the above method arrangements.

In an example arrangement, a computer storage medium is also provided. When the instructions in the computer storage medium are executed by the processor of the electronic device, the electronic device can perform the steps of the method provided in any of the above arrangements.

In an example arrangement, a computer program product is also provided. The computer program product includes the computer program/instruction. The computer program/instruction implements the method provided in any one of the above arrangements when executed by a processor. In some arrangements of the disclosure, the computer program is stored in a computer-readable storage medium. The processor of the electronic device reads the computer program from the computer-readable storage medium. The processor executes the computer program, so that the electronic device executes the method provided in any one of the foregoing arrangements.

Those of ordinary skill in the art can understand that all or part of the processes in the methods of the above arrangements can be implemented by instructing relevant hardware through a computer program. The computer program can be stored in a non-volatile computer-readable storage medium. When the computer program is executed, it may include the processes of the above-mentioned method arrangements. Any reference to memory, storage, database or other medium used in the various arrangements provided in this application may include non-volatile and/or volatile memory. The non-volatile memory may include read only memory (ROM), programmable ROM (PROM), electrically programmable ROM (EPROM), electrically erasable programmable ROM (EEPROM), or flash memory. The volatile memory may include random access memory (RAM) or external cache memory. By way of illustration and not limitation, RAM is available in various forms, such as static RAM (SRAM), dynamic RAM (DRAM), synchronous DRAM (SDRAM), double data rate SDRAM (DDRSDRAM), enhanced SDRAM (ESDRAM), Synchlink DRAM (SLDRAM), Rambus direct RAM (RDRAM), direct memory bus dynamic RAM (DRDRAM), and memory bus dynamic RAM (RDRAM) and so on.

Those skilled in the art will easily think of other arrangements of the disclosure after considering the description and practicing the disclosure disclosed herein. The disclosure is intended to cover any variations, uses, or adaptive changes of the disclosure. These variations, uses, or adaptive changes follow the general principles of the disclosure and include common knowledge or conventional technical means in the technical field not disclosed in the disclosure. The description and the arrangements are only regarded as example, and the true scope and spirit of the disclosure are indicated by the following claims.

It should be understood that the disclosure is not limited to the precise structure that has been described above and shown in the drawings, and various modifications and changes can be made without departing from its scope. The scope of the disclosure is limited only by the appended claims.

What is claimed is:

1. A method for processing a resource, comprising:
acquiring resource presentation data determined based on a resource style type of a resource and account information of a third user account, wherein the resource presentation data comprises presentation data of joint virtual space, an account of the joint virtual space comprises a first user account for activating the joint virtual space and a second user account participating in the joint virtual space, the second user account and the third user account meet a first condition related to association;
determining user information corresponding to the second user account from the resource presentation data; and
determining target resource presentation data of the resource based on the user information corresponding to the second user account, wherein the target resource presentation data is bound with the joint virtual space.

2. The method according to claim 1, further comprising:
acquiring joint virtual presentation data based on the user information corresponding to the second user account and playback data of the joint virtual space, wherein the joint virtual presentation data comprises playback segment data of the second user account in the joint virtual space, or playback segment data that meets a second condition in the joint virtual space;
said determining the target resource presentation data of the resource based on the user information corresponding to the second user account comprises:
determining the target resource presentation data of the resource based on the user information corresponding to the second user account and the joint virtual presentation data.

3. The method according to claim 1, further comprising:
acquiring the resource style type of the resource and the account information of the third user account;
generating a presentation data acquisition request, wherein the presentation data acquisition request comprises the resource style type and the account information of the third user account;
wherein resource presentation data is determined based on the resource style type and the account information of a third user account by the following process:
determining the joint virtual space that uses the second user account meeting the first condition with the third user account as an invited account based on the account information of the third user account;
acquiring virtual space related information and user information of the first user account for activating the joint virtual space based on the resource style type; and
determining the resource presentation data in combination with the user information corresponding to the second user account.

4. The method according to claim 3, wherein said determining the user information corresponding to the second user account from the resource presentation data comprises:
parsing additional field data corresponding to the second user account from the resource presentation data;
determining the user information corresponding to the second user account based on the additional field data.

5. The method according to claim 1, wherein the user information corresponding to the second user account comprises at least one of a user ID, a user portrait, a user nickname, and a virtual space cover;
the first condition comprises the second user account is at least one of a user account followed by the third user account, a user account that belongs to an identical city as a geographic location of the third user account, a user account searched through a terminal corresponding to the third user account, and a user account having a recommended matching degree with the third user account reaching a matching degree threshold.

6. The method according to claim 1, further comprising:
sending the target resource presentation data to the third user account, such that a terminal where the third user account is located presents the target resource presentation data; or,
presenting the target resource presentation data.

7. A method for processing a resource, comprising:
acquiring a presentation data acquisition request, wherein the presentation data acquisition request comprises a resource style type of a resource and account information of a third user account;
determining resource presentation data based on the resource style type and the account information of the third user account, wherein the resource presentation data comprises presentation data of joint virtual space, an account of the joint virtual space comprises a first user account for activating the joint virtual space and a second user account participating in the joint virtual space, the second user account and the third user account meet a first condition related to association; and
sending the resource presentation data, wherein the resource presentation data is used to determine user information corresponding to the second user account, the user information corresponding to the second user account is used to determine target resource presentation data of the resource, the target resource presentation data is bound with the joint virtual space.

8. The method according to claim 7, wherein said determining the resource presentation data based on the resource style type and the account information of the third user account comprises:
determining the joint virtual space that uses the second user account meeting the first condition with the third user account as an invited account based on the account information of the third user account;
acquiring virtual space related information and user information corresponding to the first user account for activating the joint virtual space based on the resource style type, and determining the resource presentation data in combination with the user information corresponding to the second user account.

9. An apparatus for processing a resource, comprising:
a processor;
a memory for storing instructions executable by the processor,
wherein the processor is configured to:
acquire resource presentation data determined based on a resource style type of a resource and account information of a third user account, wherein the resource presentation data comprises presentation data of joint virtual space, an account of the joint virtual space comprises a first user account for activating the joint virtual space and a second user account participating in the joint virtual space, the second user account and the third user account meet a first condition related to association;
determine user information corresponding to the second user account from the resource presentation data; and
determine target resource presentation data of the resource based on the user information corresponding to the second user account, wherein the target resource presentation data is bound with the joint virtual space.

10. The apparatus according to claim 9, wherein the processor is further configured to:
acquire joint virtual presentation data based on the user information corresponding to the second user account and playback data of the joint virtual space, wherein the joint virtual presentation data comprises playback segment data of the second user account in the joint virtual space, or playback segment data that meets a second condition in the joint virtual space;
determine the target resource presentation data of the resource based on the user information corresponding to the second user account and the joint virtual presentation data.

11. The apparatus according to claim 9, wherein the processor is further configured to:
acquire the resource style type of the resource and the account information of the third user account;
generate a presentation data acquisition request, wherein the presentation data acquisition request comprises the resource style type and the account information of the third user account;
wherein resource presentation data is determined based on the resource style type and the account information of a third user account by the following process:
determining the joint virtual space that uses the second user account meeting the first condition with the third user account as an invited account based on the account information of the third user account;
acquiring virtual space related information and user information of the first user account for activating the joint virtual space based on the resource style type; and
determining the resource presentation data in combination with the user information corresponding to the second user account.

12. The apparatus according to claim 11, wherein the processor is further configured to:
parse additional field data corresponding to the second user account from the resource presentation data;
determine the user information corresponding to the second user account based on the additional field data.

13. The apparatus according to claim 9, wherein the user information corresponding to the second user account comprises at least one of a user ID, a user portrait, a user nickname, and a virtual space cover;
the first condition comprises the second user account is at least one of a user account followed by the third user account, a user account that belongs to an identical city as a geographic location of the third user account, a user account searched through a terminal corresponding to the third user account, and a user account having a recommended matching degree with the third user account reaching a matching degree threshold.

14. The apparatus according to claim 9, wherein the processor is further configured to:
send the target resource presentation data to the third user account, such that a terminal where the third user account is located presents the target resource presentation data; or,
present the target resource presentation data.

15. A computer program product, comprising a computer program, wherein, when executed by a processor, the computer program implements the method for processing a resource according to claim 1.

16. A computer program product, comprising a computer program, wherein, when executed by a processor, the computer program implements the method for processing a resource according to claim 7.
